(19) United States
(12) Patent Application Publication
(10) Pub. No.: US 2025/0192454 A1
(43) Pub. Date: Jun. 12, 2025

(54) CONDUCTOR CONNECTION TERMINAL

(71) Applicant: WAGO Verwaltungsgesellschaft mbH, Minden (DE)

(72) Inventor: Justin RENGEL, Porta Westfalica (DE)

(73) Assignee: WAGO Verwaltungsgesellschaft mbH, Minden (DE)

(21) Appl. No.: 18/971,969

(22) Filed: Dec. 6, 2024

(30) Foreign Application Priority Data
Dec. 6, 2023 (DE) 20 2023 107 231.3

(51) Int. Cl. H01R 4/48

(52) U.S. Cl. CPC H01R 4/4833; H01R 4/483; H01R 4/4835; H01R 4/48365; H01R 4/4846; H01R 4/4842

(57) ABSTRACT

A conductor connection terminal with a spring-force clamping connection, which has a busbar and a clamping spring for connecting an electrical conductor to the busbar by the clamping spring. An actuator acts on an actuation section of the clamping spring for displacing a clamping leg of the clamping spring from a clamping position to an open position. The actuator has a first pusher section with a first actuation contour and a second pusher section with a second actuation contour. The actuator displaces the clamping leg by a first displacement distance through interaction of the first actuation contour with the first effective contour when the actuator is displaced by a first actuation distance, and displace the clamping leg of the clamping spring by a second displacement distance through interaction of the second actuation contour with the second effective contour when the actuator is displaced by a second actuation distance.

This nonprovisional application claims priority under 35 U.S.C. § 119(a) to German Patent Application No. 20 2023 107 231.3, which was filed in Germany on Dec. 6, 2023, and which is herein incorporated by reference.

### BACKGROUND OF THE INVENTION

### Field of the Invention

The invention relates to a conductor connection terminal with a spring-force clamping connection.

### Description of the Background Art

In conductor connection technology, conductor connection terminals with spring-force clamping connections are known. A spring-force clamping connection is an electromechanical conductor connection with a clamping spring, with which an electrical conductor can be clamped to a busbar of the conductor connection terminal by means of spring force. By means of a spring-force clamping connection, an electrical conductor can be connected easily and with little effort and securely contacted, as well as released again by an appropriate actuation of the spring-force clamping connection.

To actuate the spring-force clamping connection, it is known to arrange a mechanical actuator, such as an actuating lever or pusher, on the conductor connection terminal that can shift a clamping leg of the clamping spring from a clamping position to an open position to facilitate the insertion of an electrical conductor into the conductor connection terminal in the area of the clamping point or to release a connected electrical conductor.

In practice, it is desirable to provide conductor connection terminals that are as small and compact as possible in order to enable the connection of electrical conductors even in confined spaces. In addition, simple and convenient handling of the conductor connection terminals is desired. The conductor connection terminal should also be as robust and reliable as possible. The simplest possible yet most effective actuation of the conductor connection terminal with low force requirements and compact design represents a design challenge with great potential for further development.

### SUMMARY OF THE INVENTION

It is therefore an object of the invention to provide a conductor connection terminal with an improved actuation mechanism which, in a compact design, enables effective actuation of the spring-force clamping connection with little effort.

In an example, a conductor connection terminal with a spring-force clamping connection is proposed, which has a busbar and a clamping spring for connecting an electrical conductor to the busbar by means of the clamping spring, wherein the conductor connection terminal has an actuator acting on an actuation section of the clamping spring for displacing a clamping leg of the clamping spring from a clamping position to an open position. The actuator has a first pusher section with a first actuation contour and a second pusher section with a second actuation contour. The actuation section of the clamping spring has a first effective contour and a second effective contour, wherein the actuator is set up to: displace the clamping leg of the clamping spring by a first displacement distance through interaction of the first actuation contour with the first effective contour when the actuation element is displaced by a first actuation distance, and displace the clamping leg of the clamping spring by a second displacement distance through interaction of the second actuation contour with the second effective contour when the actuator is displaced by a second actuation distance.

In other words, a conductor connection terminal with a multi-speed actuator is proposed, which allows for a step-by-step displacement of the clamping leg of the clamping spring during an actuation by means of successive actuation contours coming into engagement with different effective contours of the actuation section of the clamping spring.

This makes it possible to use several actuation contours on the actuator one after the other for the actuation of the spring-force clamping connection during an actuation of the actuator, so that the actuator can be designed compactly. In the case of actuators with only one actuation contour, this must be designed in such a way that, in conjunction with the effective contour of the actuation section of the clamping spring, it is suitable for displacing the clamping leg of the clamping spring over the entire required displacement distance. With the proposed actuation mechanism, the displacement distance is divided into several actuation and effective contours, which can interact one after the other over the entire actuation distance of the actuator. By using several actuation and effective contours, larger displacement distance of the clamping leg can be implemented with the compact design of the actuator. Due to the compact actuation mechanism, the conductor connection terminal can also be used in confined spaces. In addition, the actuator can be actuated with a uniform amount of force over the actuation distance, making it easier to handle the conductor connection terminal. As a result, a conductor connection terminal can be provided with an improved actuation mechanism, which enables effective actuation of the spring-force clamping connection with low force in a compact design.

The actuator can be a translationally displaceable actuating pusher. In this case, the first pusher section can be offset from the second pusher section in the direction of the translational displacement of the actuating pusher in order to divide the translational displacement distance into several actuation and effective contours.

However, the actuator can also be a swiveling actuating lever. In this case, the first pusher section may be offset from the second pusher section in the direction of movement described on a respective curve track when the actuating lever is swiveled, in order to divide the displacement distance into several actuation and effective contours following a trajectory. The trajectories of the first and second pusher sections can coincide or run parallel to each other, i.e., lie on a common wider curve track.

The clamping spring can be a one-piece spring component with elastically deflectable and/or elastically deformable spring sections, which is suitable for exerting a spring force on adjacent component structures.

The clamping spring may have an elastically deflectable clamping leg, which is designed to connect an electrical conductor to the conductor connection terminal and is arranged opposite the busbar.

The clamping spring can have a contact leg with which the clamping spring can be supported on surrounding component structures. The contact leg can be connected to the clamping leg via a spring arch.

The clamping spring can have an actuation section coupled to the clamping leg, on which the actuator can engage in order to displace the clamping leg by a displacement distance, for example to swivel the spring arch, by means of an elastic displacement or deformation of the actuation section. As the displacement distance increases, a distance between the clamping leg and the busbar opposite the clamping leg is increased, so that an electrical conductor can be inserted or removed between the clamping leg and the busbar. The displacement distance of the clamping leg can be limited to a maximum displacement distance, hereinafter also referred to as the complete displacement distance, for example by a clamping leg stop formed on the clamping spring. A position of the clamping leg in which there is sufficient distance between the clamping leg and the busbar to allow for a conductor to be inserted or removed between the clamping leg and the busbar is called an open position. A position of the clamping leg in which the clamping leg rests against the busbar or a conductor clamps against the busbar is called a clamping position. The busbar can be a one-piece component. According to an example, the busbar can have a material passage with a pull-through collar, on the inside of which an electrical conductor can be clamped by means of the clamping leg of the clamping spring.

The actuator can be an actuating pusher for the mechanical actuation of the spring-force clamping connection, which performs a predominantly translational actuation movement when actuated, while an actuating lever is predominantly rotationally moved and swiveled about a swivel axis. According to this, the actuating pusher can be moved predominantly axially in the direction of actuation along its longitudinal axis.

For example, the actuating pusher can be designed as an elongated, rod-shaped or tine-shaped component. The longitudinal axis can be a component axis of the actuating pusher with the greatest widening. The translational direction of actuation and the longitudinal axis of the actuating pusher may be rectified.

The actuating pusher can have an actuation surface on one front side for the manual or tool-assisted introduction of an actuation force, for example, in order to be able to displace the actuating lever translationally. Depending on the example, the actuation contour provided for the respective mechanical contacting of the actuation section may be arranged on a front side facing the clamping spring, which may be arranged opposite an actuation surface, for example, or on a circumference of the actuating pusher between its front sides.

The first pusher section with the first actuation contour and the second pusher section with the second actuation contour may be arranged sequentially along the longitudinal axis of the actuating pusher, with the first pusher section located closer to the actuation section of the clamping spring than the second pusher section. In the case of a translational movement of the actuating pusher in the direction of the actuation section of the clamping spring, the actuating pusher travels an actuation distance.

The traveled actuation distance of the actuator during an interaction of the first actuation contour with the first effective contour of the actuation section can be referred to as the first actuation distance, and the traveled actuation distance of the actuator during an interaction of the second actuation contour with the second effective contour of the actuation section is referred to as the second actuation distance.

The second actuation contour can be offset from the first actuation contour, for example radially and/or axially offset, wherein a radial and axial offset in combination in particular enables an advantageous spacing and defined separation between the first and second actuation contours. In other words, in the case of a radial offset, the first and second actuation contours may be arranged next to each other in the direction of the width of the actuator and, in the case of an axial offset, in the longitudinal direction of the actuator.

The actuator can be designed as a one-piece component, so that the first and second actuation contours are integrally formed with the actuator. The actuator may have a pusher stop to limit its translational movement in the direction of actuation in order to define a maximum actuation distance of the actuator.

An interaction of an actuation contour with an effective contour can be understood to mean that the actuation contour and the effective contour contact each other mechanically and that the actuation contour exerts a mechanical force on the effective contour which leads to a displacement of the actuation section and the clamping leg of the clamping spring coupled with it. The actuation contour and the effective contour can have contour surfaces facing each other, which, depending on the design, can also slide on top of each other to enable continuous displacement during their interaction.

The first actuation contour and the first effective contour as well as the second actuation contour and the second effective contour can each form different surface pairings in terms of their shape, dimension and/or orientation to each other, so that it is ensured that the first actuation contour interacts only with the first effective contour and the second actuation contour only with the second effective contour. Alternatively or additionally, it may be provided that the first pusher section has a cross-sectional shape and/or cross-section size that differs from the second pusher section and that the actuation section in the area of the effective contours has a guide contour adapted to the respective pusher section, so that it is ensured that the first actuation contour only interacts with the first effective contour and the second actuation contour only with the second effective contour.

For example, the first and second effective contours may be arranged one behind the other in a longitudinal direction of the actuation section of the clamping spring and next to each other in a direction of the width of the actuation section. Examples of geometrical assignment options for actuation, effective or guiding contours are explained below in connection with advantageous examples.

In principle, the number of actuation contours on the actuator and the number of effective contours on the actuation section of the clamping spring are not limited to two each, but more than two actuation contours and more than two effective contours may also be provided. This allows for a complete displacement distance of the clamping leg to be divided into more than two partial displacement distances and an entire actuation distance of the actuator into more than two partial actuation distances, so that the actuation can be further facilitated or larger displacement distances can be implemented. In other words, any number of actuation levels can be implemented using the multi-speed actuation element.

The actuation section of the clamping spring can be designed as a clamping yoke. This allows for the actuation section and, accordingly, the clamping leg of the clamping spring coupled to the actuation section to be easily and reliably displaced by means of the actuator. A clamping yoke may be a frame-like actuation section with an opening into which the actuator can be immersed and, with its actuation contour adjoining an effective contour of the clamping yoke, exert a compressive force on the clamping yoke, which is transmitted as a tensile force to the clamping leg coupled to the clamping yoke and pulls the clamping leg into the open position. For example, the clamping yoke can protrude from the clamping leg between a free end of the clamping leg and the spring arch.

The first and second effective contours of the clamping yoke can be formed as guide surfaces protruding from the clamping yoke and spaced from each other. For example, the guide surfaces can be material tabs bent from the clamping yoke that are bent in a direction that essentially corresponds to the translational direction of an actuating pusher, so that the translationally moved actuating pusher is guided along a guide surface when an actuation distance is traveled.

A guide surface can be shaped, dimensioned and/or aligned in such a way that it is adapted to the respective assigned actuation contour. For example, the first effective contour of the clamping yoke designed as a guide surface may have the same width and/or inclination with respect to the longitudinal axis of the actuator as the first actuation contour, and the second effective contour of the clamping yoke formed as a guide surface may have the same width and/or inclination with respect to the longitudinal axis of the actuator as the second actuation contour.

The distance between the first effective contour and the second effective contour may essentially correspond to the first displacement distance of the clamping leg when the first actuation contour interacts with the first effective contour, so that after the first displacement distance has been covered, the second actuation contour engages with the second effective contour and the second displacement distance can be covered through interaction of the two contours. The first effective contour may be arranged at a cross-connection of the frame-shaped clamping yoke opposite the coupling to the clamping leg or form such a cross-connection. The second effective contour can be arranged between the coupling and the cross-connection of the clamping yoke and, for example, protrude from a lateral frame bar of the clamping yoke as a divided guide surface.

Alternatively or additionally, the clamping yoke can have a first engagement area with a first guide contour for the first pusher section of the actuator and a second engagement area with a second guide contour for the second pusher section of the actuator. In particular, the guide contours of the first and second engagement areas may be designed differently and adapted to a cross-sectional shape and/or cross-section size of the respective assigned pusher section. The engagement areas can be connected to each other and together form an opening within the frame-shaped clamping yoke. By providing a separate engagement area for the first and second pusher sections, in particular with guide contours adapted to the pusher sections, it can be predefined and controlled by design that the first actuation contour of the actuator interacts with the first effective contour of the actuation section and that the second actuation contour of the actuation element interacts with the second actuation contour of the actuation section.

The first engagement area may have a smaller cross-sectional area than the second engagement area, and the first pusher section may have a smaller cross-sectional area than the second pusher section. As a result, the engagement areas are adapted to different cross-section sizes of the assigned pusher sections and can control the gradual displacement of the clamping leg by geometric fit. For example, the first engagement area can form a guide contour that matches the circumferential contour or cross-sectional shape of the first pusher section, allowing it to dip into the first engagement area. The second engagement area, for example, can form a step-like widening as compared to the first engagement area. The second pusher section of the actuator may have a corresponding cross-sectional widening as compared to the first pusher section, through which the second pusher section can be immersed in the extended second engagement area, but not in the first engagement area. In other words, a narrow first pusher section can engage in a narrow slot in the actuation section of the clamping spring and deflect the clamping leg by a first displacement distance, and a wide second pusher section can engage a wide slot of the actuation section of the clamping spring and deflect the clamping leg by a second displacement distance. The actuator can perform a continuous actuation movement.

The first actuation contour and/or the second actuation contour of the actuation element may be designed as a ramp surface. The ramp surface can form an inclined plane with respect to a direction of displacement of the actuator when actuated, i.e., an inclined plane with respect to the translational direction of an actuating pusher or with respect to the direction of rotation of an actuating lever. An actuation contour designed as a ramp surface enables the actuation contour to gently surface on the effective contour of the actuation section and a gradual displacement of the clamping leg over the actuation section. The ramp surface can be inclined in relation to a longitudinal axis of the actuator. In other words, the first and/or second actuation contours may be arranged at an angle relative to a longitudinal widening of the actuator. The pusher sections may have a wedge shape in the area of the first and/or second actuation contour, in which the bevel surface of the wedge forms the ramp surface. The ramp surface can, for example, face a guide surface of an actuation section designed as a clamping yoke. The ramp surface can cause a gradual displacement of the clamping leg by introducing a compressive force into the effective contour of the actuation section and transferring a corresponding tensile force to the clamping leg. If the first actuation contour and the second actuation contour of the actuator are designed as ramp surfaces, a very narrow actuation element can be provided, wherein the actuation contours can implement a multiple displacement distance of the clamping leg through their successive interaction with the effective contours of the actuation section during actuation. A distance between the first and second actuation contours may correspond to at least one pusher width at the widest point of the wedge shape of the first pusher section, so that the clamping leg can be shifted by the pusher width at the widest point of the wedge shape of the first pusher section as the first displacement distance during the first actuation distance of the actuator and subsequently be shifted by the pusher width at the widest point of the wedge shape of the second pusher section as a second displacement distance.

If the first actuation contour and the second actuation contour of the actuator are designed as ramp surfaces, it may be provided that the respective angle of inclination of the first and second actuation contours designed as ramp surfaces differs from each other in relation to a longitudinal axis of the actuator. For example, the first actuation contour may have a greater inclination with respect to the longitudinal axis of the actuator than the second actuation contour, or vice versa. This provides ramp surfaces of varying steepness, so that different force ratios can be implemented during the first and second actuation distance of the actuator, which can be used, for example, for an easier deflection of the clamping leg in the direction of the opening position of the clamping leg with increasing spring counterforce. The angle of inclination of the ramp surface can define a slope of the ramp. The slope can be continuous along the ramp surface or vary, for example, increase. The slopes of the ramps of the first and second actuation contours may be designed in such a way that the force to be applied to the actuator and/or the actuation force transmitted to the clamping leg is essentially uniform over the entire actuation distance of the actuator. The first actuation contour may point in the same direction as the second actuation contour.

The first actuation contour can form an end face of the actuator. The end face can be located on the front end of a free end of the actuator, which is designed in particular as an elongated component, and may, for example, be opposite another end face of the actuator designed as an actuation surface. The first actuation contour can hit the actuation section of the clamping spring as the first face during translation of the actuation element in the direction of actuation and act on the first effective contour of the actuation section. Depending on the example, the end face can form an orthogonal transverse surface of the actuator or an inclined ramp surface. If the end face of the actuator is formed as the first actuation contour, a compact design of the actuator can be provided.

The second actuation contour may be staggered to the first actuation contour. This allows for a second actuation contour to be formed which is offset in a defined manner from the first actuation contour, to which the second effective contour of the actuation section can be geometrically adapted. The second actuation contour may protrude laterally from the first actuation contour to form a step, wherein the step surface can form the second actuation contour. Depending on the example, the step surface can form an orthogonal transverse surface or an inclined ramp surface of the actuator at its circumference. Due to the stepped offset, the actuator can be given an asymmetrical shape, which can be used, for example, to control the actuation of the clamping leg via the first and second pusher sections of the actuator via a corresponding asymmetrical shaping of the engagement areas of an actuation section of the clamping spring designed as a clamping yoke. With an asymmetrical shape, an even more compact, slim actuator can be provided. In other words, if the first and second actuation contours are designed as ramp surfaces, the actuator may have two sloping actuation surfaces graduated in width, which interact with mating surfaces of different widths as effective contours on the actuation section of the clamping spring.

The actuator may have two second actuation contours on opposite sides of the first actuation contour offset in steps to the first actuation contour. This enables a more uniform transmission of force from the second actuation contour to the second effective contour. In addition, the actuator can thereby be given a symmetrical shape with a cross-section widening at the transition of the first pusher section into the second pusher section, which can be used, for example, via a corresponding symmetrical shape and cross-sectional widening of the engagement areas of an actuation section of the clamping spring designed as a clamping yoke to control the actuation of the clamping leg via the first and second pusher sections of the actuator.

The effective contours of the actuation section formed, for example, as guide surfaces may be designed to match a single protruding step or to two opposing steps of the second actuation contour, for example as a single guide surface on one side of the actuation section or as a split guide surface on two opposite sides of the actuation section.

The busbar and/or the clamping spring may have a guide section on which the actuator can slide during its displacement. This allows for the actuating pusher to be additionally stabilized and guided during an actuation process. For example, the busbar may have a material tongue bent below the actuation section of the clamping spring, which forms the guide section. The busbar may also have a support section on which a contact leg of the clamping spring is supported, wherein one side of the support section facing away from the contact leg may have the guide section for the actuator. Furthermore, it is conceivable that the actuator slides off the contact leg of the clamping spring, so that the guide section can be arranged on the contact leg.

The spring-force clamping connection may have a reset mechanism that is configured to automatically shift the clamping leg from the open to the clamping position when a conductor is inserted into the conductor connection terminal. In order to initially hold the clamping spring in the open position for the return, retaining contours designed for form-fitting latching at least on the clamping spring or an additional retaining element are required. The reset mechanism, which can be triggered with an inserted electrical conductor, eliminates the need for a user of the conductor connection terminal to activate the return of the clamping leg to the clamping position and further simplifies the handling of the conductor connection terminal. Conductor connection terminals with such a reset mechanism are also referred to as snap-in conductor connection terminals, for example. A return of the clamping leg to the clamping position can be triggered with such a reset mechanism, for example, by mechanically contacting the inserted conductor with a release element. Depending on the example, the actuation element can be returned to its original position before it is actuated by the return mechanism or it can be decoupled from the reset mechanism and returned manually.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a-1c show an actuating pusher for a conductor connection terminal according to an example in a perspective front view, a side view and a front view;

FIGS. 2a-2c show an actuating pusher for a conductor connection terminal according to an example in a perspective front view, a side view and a front view;

FIGS. 3a-3b show a conductor connection terminal according to an example in an unactuated state in a cut side view and a perspective front view;

FIG. 3c shows an isolated representation of an actuator, a clamping spring and a busbar of the conductor connection terminal according to FIG. 3a-3b in a side view;

FIG. 3d shows an isolated representation of the actuator and the clamping spring of the conductor connection terminal according to FIG. 3a-3b in a perspective front view;

FIGS. 4a-4b shows the conductor connection terminal according to FIG. 3a-3b in a half-actuated state in a cut side view and a perspective front view;

FIG. 4c shows an isolated representation of the actuator, the clamping spring and the conductor connection terminal busbar according to FIG. 4a-4b in a side view;

FIG. 4d shows an isolated representation of the actuator and the clamping spring of the conductor connection terminal according to FIG. 4a-4b in a perspective front view;

FIGS. 5a-5b show the conductor connection terminal according to FIG. 3a-3b in a fully actuated state in a cut side view and a perspective front view;

FIG. 5c shows an isolated representation of the actuator, the clamping spring and the conductor connection terminal busbar according to FIG. 5a-5b in a side view; and

FIG. 5d shows an isolated representation of the actuator and the clamping spring of the conductor connection terminal according to FIG. 5a-5b in a perspective front view;

FIG. 6a shows side section view of an example of a conductor connection terminal with a swiveling actuator in the closed position;

FIG. 6b shows perspective view of the conductor connection terminal from FIG. 6a;

FIG. 6c shows side view of a spring-force clamping connection with swiveling actuator of the conductor connection terminal from FIGS. 6a and 6b;

FIG. 6d shows perspective view of the spring-force clamping connection with swiveling actuator from FIG. 6c;

FIG. 7a shows side section view of the example of the conductor connection terminal with swiveling actuator in a partially open position;

FIG. 7b shows perspective view of the conductor connection terminal from FIG. 7a in the partially open position;

FIG. 7c shows side view of the spring-force clamping connection with swiveling actuator of the conductor connection terminal from FIGS. 7a and 7b in the partially open position;

FIG. 7d shows perspective view of the spring-force clamping connection with swiveling actuator from FIG. 7c in the partially open position;

FIG. 8a shows side section view of the example of the conductor connection terminal with swiveling actuator in the open position;

FIG. 8b shows perspective view of the conductor connection terminal from FIG. 8a in the open position;

FIG. 8c shows side view of the spring-force clamping connection with swiveling actuator of the conductor connection terminal from FIGS. 8a and 8b in the open position;

FIG. 8d shows perspective view of the spring-force clamping connection with swiveling actuator from FIG. 8c in the open position;

FIG. 9a shows perspective view of the spring-force clamping connection with swiveling actuator in the closed position without busbar;

FIG. 9b shows perspective view of the spring-force clamping connection with swiveling actuator in the partially open position without busbar;

FIG. 9c shows perspective view of the spring-force clamping connection with swiveling actuator in the open position without busbar;

FIG. 10a shows side view of the example of the conductor connection

terminal with swiveling actuator in the closed position and hold-open release element;

FIG. 10b shows side view of the conductor connection terminal from FIG. 10a with swiveling actuator in the partially open position and hold-open release element;

FIG. 10c shows side view of the conductor connection terminal from FIG. 10a with swiveling actuator and clamping leg engaged in the open position on the hold-open release element;

FIG. 11a shows side view of the conductor connection terminal from FIG. 6a with swiveling actuator in the closed position;

FIG. 11b shows side view of the conductor connection terminal from FIG. 7a with swiveling actuator in the partially open position;

FIG. 11c shows side view of the conductor connection terminal from FIG. 8a with swiveling actuator in the open position;

FIG. 12a shows front view of the conductor connection terminal with section line A-A of the section view from FIG. 6a with swiveling actuator in the closed position;

FIG. 12b shows front view of the conductor connection terminal with section line B-B of the section view from FIG. 7a with swiveling actuator in the partially open position;

FIG. 12c shows front view of the conductor connection terminal with section line C-C of the section view from FIG. 8a with swiveling actuator in the open position;

FIG. 13a shows front view of the actuating lever for the example of the conductor connection terminal;

FIG. 13b shows side view of the actuating lever from FIG. 13a; and

FIG. 13c shows perspective view of the actuating lever from FIGS. 13a and 13b.

### DETAILED DESCRIPTION

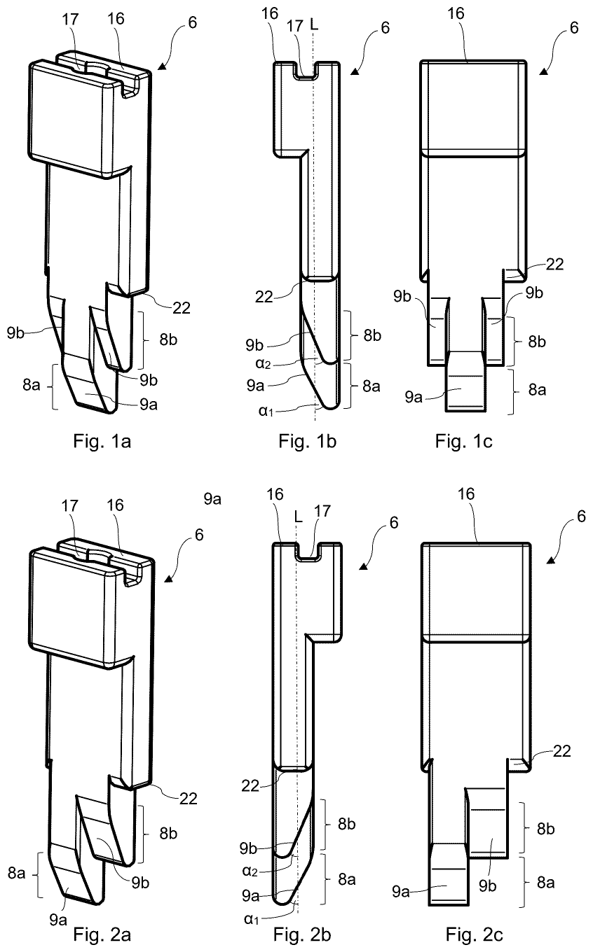

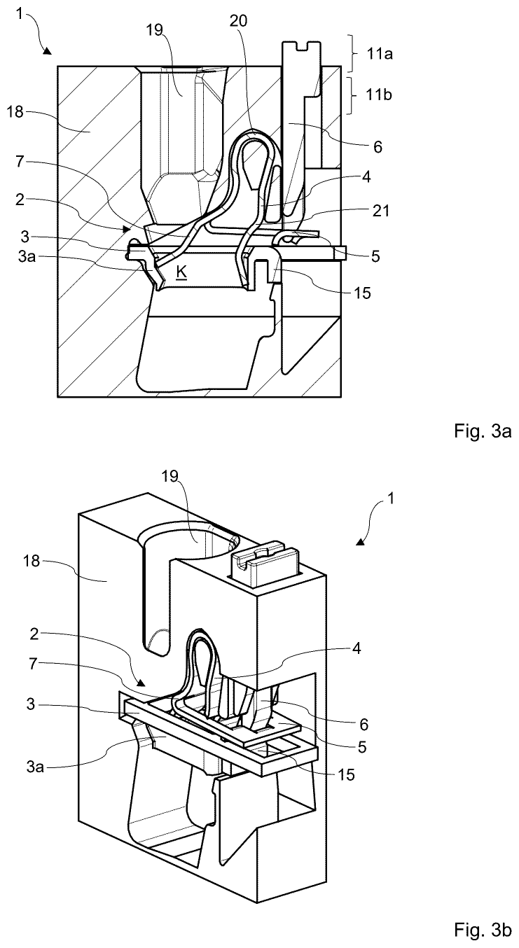

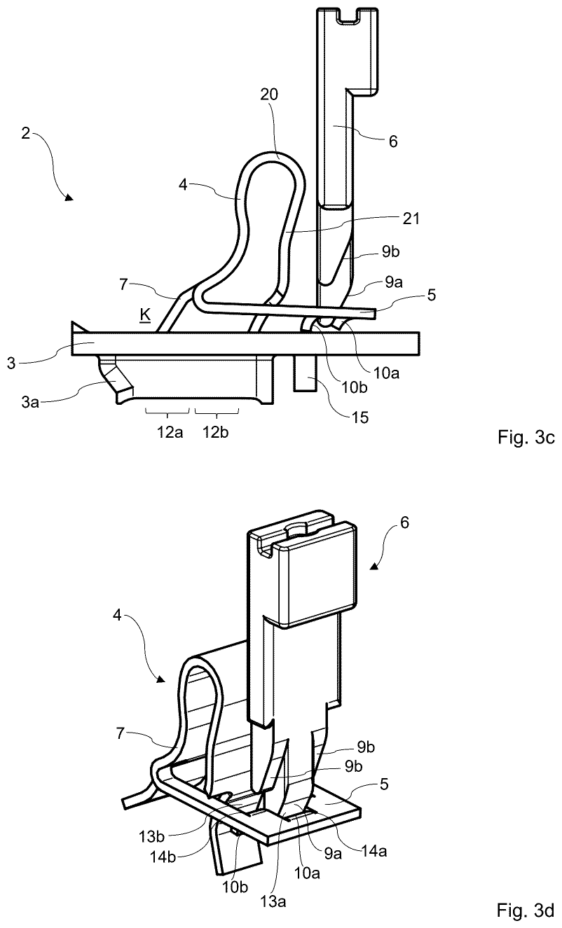

FIGS. 1a, 1b and 1c show an actuator 6 in the form of an actuating pusher for a conductor connection terminal 1 shown in FIGS. 3a-3b, 4a-4b and 5a-5b according to an example.

The actuating pusher 6 is designed as an elongated, one-piece component and has a greater widening along its longitudinal axis L than in its width and depth direction. The actuating pusher 6 is provided in the conductor connection terminal 1 for translational actuation along its longitudinal axis L. For actuation, the actuating pusher 6 has an actuation surface 16 with a tool holder 17 on an end face, via which, for example, it is possible to operate the actuating pusher 6 comfortably by applying a compressive force with a tool such as a screwdriver.

The actuating pusher 6 has a first pusher section 8a with a first actuation contour 9a and a second pusher section 8b with a second actuation contour 9b.

The second actuation contour 9b is offset axially in the direction of the longitudinal axis L relative to the first actuation contour 9a and radially to a (virtual) swivel axis of an actuation section 5 of a clamping spring 4, so that there is a defined separation between the actuation contours 9a, 9b. The actuation contours 9a, 9b are designed as ramp surfaces which run at an angle of inclination α1, α2 relative to the longitudinal axis L of the actuation pusher 6. The first actuation contour 9a forms an inclined end face of the actuating pusher 6. The second actuation contour 9b is designed as two actuation contours arranged opposite each other and protruding laterally from the first actuation contour 9a, so that an actuation pusher 6 with an essentially symmetrically designed actuation range is provided.

Furthermore, the actuating pusher 6 has at least one pusher stop 22 on the side to limit its translational displacement in the conductor connection terminal 1.

FIGS. 2a, 2b and 2c show an actuating pusher 6 for a conductor connection terminal 1 shown in FIGS. 3a-3b, 4a-4b and 5a-5b according to an example.

The actuating pusher 6 according to the example differs from the actuating pusher 6 according to the first example in the design of the first pusher section 8a with the first actuation contour 9a and the second pusher section 8b with the second actuation contour.

As can be seen from FIGS. 2a to 2c, the second actuation contour 9b is designed here as a single actuation contour offset in steps from the first actuation contour 9a, so that a narrow actuation pusher 6 with an essentially asymmetrically designed actuation range is provided.

FIGS. 3a to 3d show a conductor connection terminal 1 in different views, wherein in FIGS. 3c and 3d component groups of the conductor connection terminal 1 are shown in isolation for better illustration.

The conductor connection terminal 1 has a spring-force clamping connection 2 for the connection of an electrical conductor, which can be clamped to a busbar 3 of the conductor connection terminal 1 by means of a clamping spring 4.

As can be seen, for example, in FIG. 3c, the busbar 3 has a material passage with a pull-through collar 3a, on the inside of which the electrical conductor can be clamped by means of a clamping leg 7 of the clamping spring 4.

The conductor connection terminal 1 has an insulating material housing 18 which accommodates the spring-force clamping connection 2, which has a conductor insertion opening 19 through which the electrical conductor can be routed to the spring-force clamping connection 2 in the insulating material housing 18. The clamping spring 4 has a clamping leg 7 and a contact leg 21, which are connected to each other via a spring arch 20. The clamping leg 7 is designed for clamping an electrical conductor against the busbar 3 and can be moved for this purpose between a clamping position K and an open position O, in which a conductor can be inserted between the clamping leg 7 and the busbar 3. In FIGS. 3a to 3d, the clamping leg 7 is shown in a clamping position K.

For the displacement of the clamping leg 7 from the clamping position K to the open position O, an actuating pusher 6 is arranged in the conductor connection terminal 1 according to the first example shown in FIGS. 1a to 1c, wherein in principle an actuating pusher 6 according to the second example could also be used in an analogous manner. In order to displace the clamping leg 7 from the clamping position K to the open position O, the clamping spring 4 also has an actuation section 5 coupled with the clamping leg 7, on which the actuating pusher 6 can engage in order to displace the clamping leg 7. The actuation section 5 has a first effective contour 10a and a second effective contour 10b, which can be seen, for example, in FIG. 3c.

The actuating pusher 6 is set up to shift the clamping leg 7 of the clamping spring 4 by a first displacement distance 12a shown in FIG. 3c when translated by a first actuation distance 11a shown in FIG. 3a through interaction of the first actuation contour 9a with the first effective contour 10a, and when translated by a second actuation distance 11b through interaction of the second actuation contour 9b with the second effective contour 10b by a second displacement distance 12b. This results in a multi-speed, compact actuating pusher 6 with an efficient design, with which a multi-step displacement of the clamping leg 7 can be implemented. When actuated, the actuating pusher 6 engages successively with its actuation contours 9a, 9b with the first and second effective contours 10a, 10b, in order to displace the clamping leg 7 successively by the displacement distances 12a, 12b. The conductor connection terminal 1 can thus be operated effectively with a small and uniform effort.

As can be seen in FIG. 3c, the actuation contours 9a, 9b and the effective contours 10a, 10b have contour surfaces facing each other, which can slide off each other, so that a gradual displacement of the clamping leg 7 can be implemented. The contour surfaces are different in terms of their arrangement in order to separate the interaction of the first actuation contour 9a with the first effective contour 10a and the second actuation contour 9b with the second effective contour 10b from each other and to control the successive engagement of the contours with each other. For example, the effective contour 10b is designed as a divided guide surface and is arranged closer to the sides of the actuation section 5 than the more centrally arranged contiguous guide surface of the effective contour 10a.

As can be seen, for example, in FIGS. 3b and 3d, the actuation section 5 of the example shown is designed as a clamping yoke in order to simplify the displacement of the clamping leg 7 by means of the actuating pusher 6. The clamping yoke protrudes between a free end of the clamping leg 7 and the spring arch 20 of the clamping spring 4.

The effective contours 10a, 10b protrude from the clamping yoke as guide surfaces. The clamping yoke has a first engagement area 13a with a first guide contour 14a for the first pusher section 8a of the actuating pusher 6 and a second engagement area 13b with a second guide contour 14b for the second pusher section 8b of the actuator pusher 6. The second engagement area 13b is wider and therefore has a larger cross-sectional area than the narrower first engagement area 13a. As a result, the engagement areas 13a, 13b are geometrically adapted to the pusher sections 8a, 8b. The first pusher section 8a is narrower than the second pusher section 8b and therefore has a smaller cross-sectional area than the second pusher section 8b.

The second engagement area 13b forms a step-like widening against the first engagement area 13a. The geometrical adjustment of the engagement areas 13a, 13b to the pusher sections 8a, 8b ensures that the first actuation contour 9a interacts with the first effective contour 10a and the second actuation contour 9b with the second effective contour 10b. The actuation contours 9a, 9b, which are designed as ramp surfaces and run at an angle of inclination α1, α2 relative to the longitudinal axis L of the actuating pusher 6, enable a smooth running of the actuation contours 9a, 9b along the effective contours 10a, 10b and a gradual displacement of the clamping leg 7. As can be seen in FIG. 3a, the busbar 3 has a guide section 15 on which the actuating pusher 6 can slide off during its translational displacement. Alternatively or additionally, it is also conceivable that the clamping spring 4 forms such a guide section, for example on its contact leg 21.

FIGS. 3a to 3d show the conductor connection terminal 1 as well as component groups of the conductor connection terminal 1 in an unactuated state, in which the clamping leg 7 of the clamping spring is in the clamping position K.

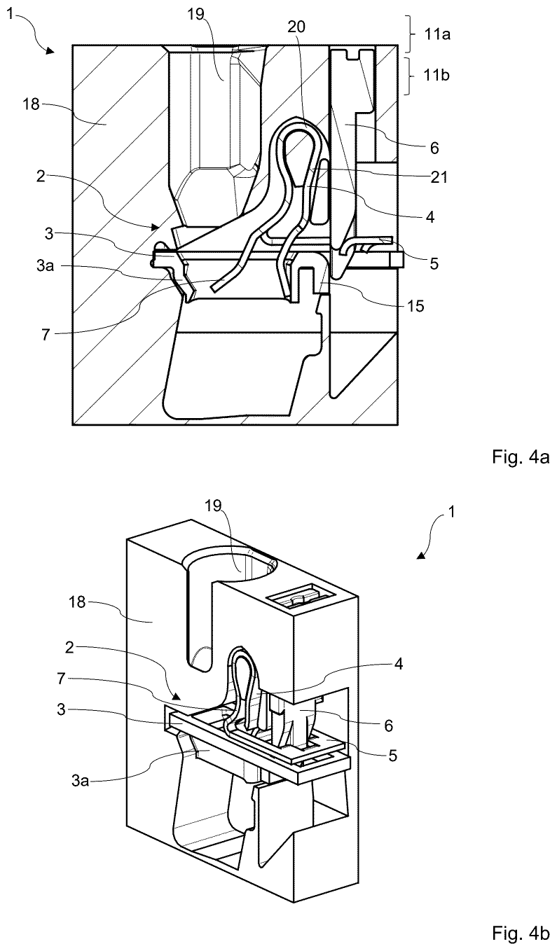

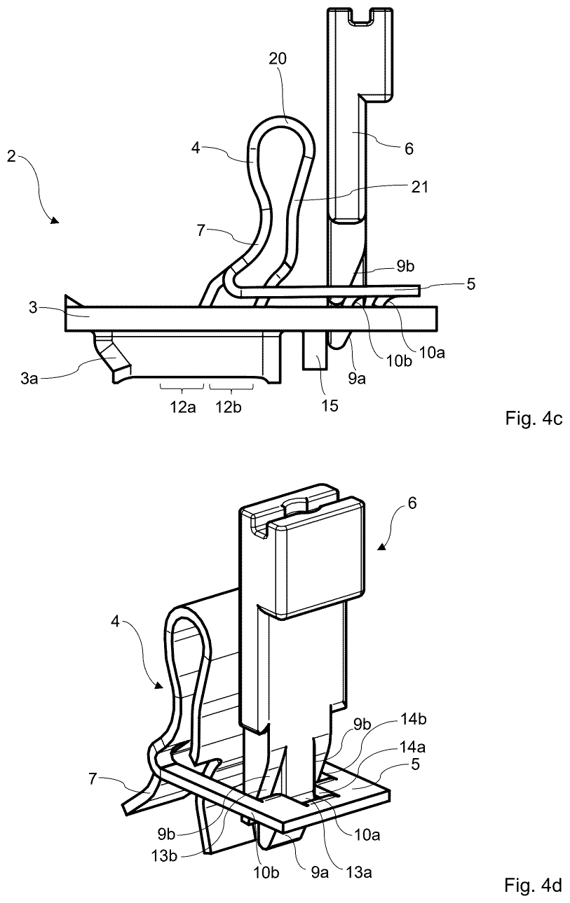

FIGS. 4a to 4d show the conductor connection terminal 1 described above in a half-actuated state, in which the actuating pusher 6 was displaced by the first actuation distance 11a and the clamping leg 7 was moved from the clamping position K by a first displacement distance 12a. In a comparison of FIGS. 3c and 4c, it can be seen that during an actuation, the first actuation contour 9a is initially engaged with the first effective contour 10a, and after a first actuation distance 11a of the actuation pusher 6 has been traveled, the second actuation contour 9b engages with the second effective contour 10b.

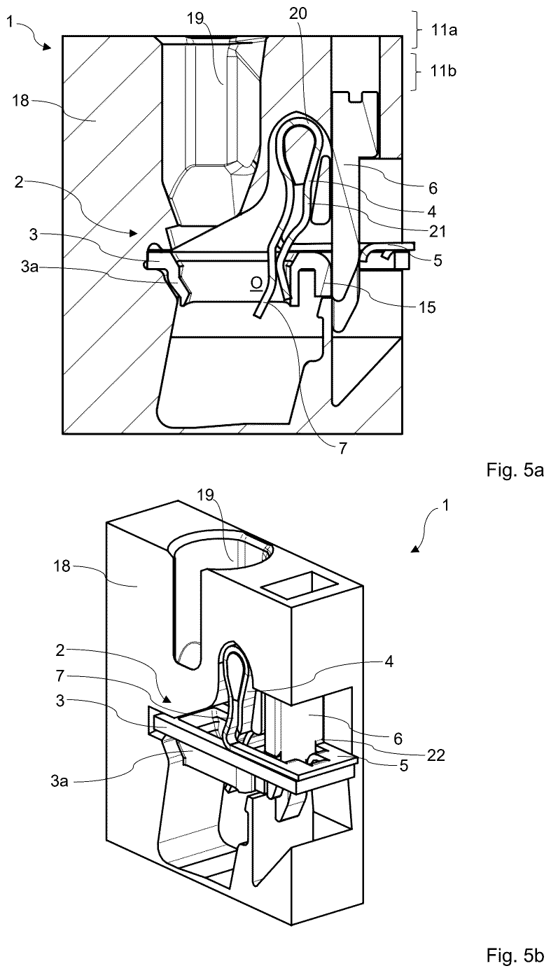

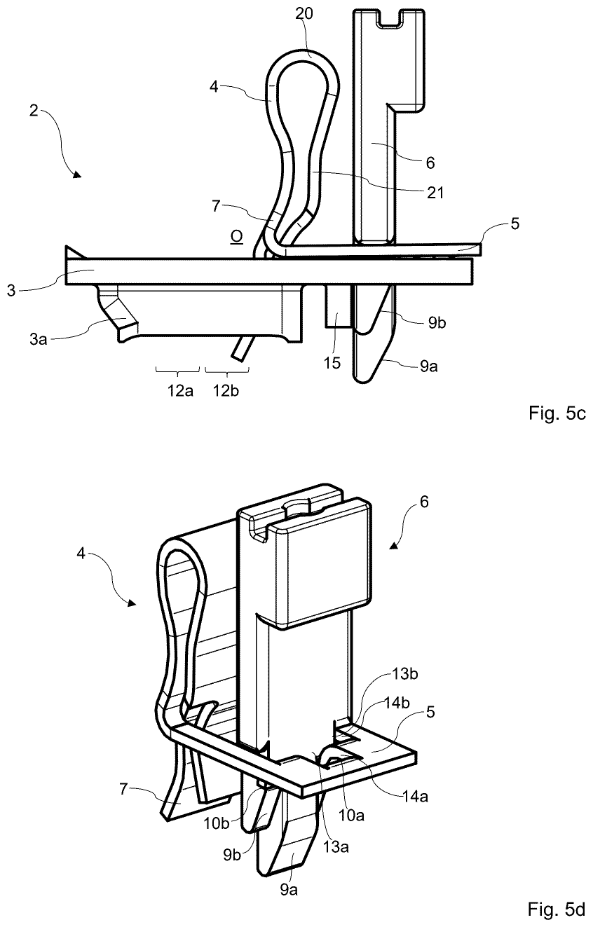

FIGS. 5a to 5d shows the conductor connection terminal 1 described above in a fully actuated state, in which the actuating pusher 6 was displaced by the second actuation distance 11b and the clamping leg 7 was moved by a second displacement distance 12b to the open position O. In addition, FIG. 5b shows how lateral pusher stops 22 of the actuating pusher 6 touch down on the clamping yoke and prevent further translation of the actuating pusher 6. A reset of the clamping leg 7 from the open position O to the clamping position K can be done, for example, by means of an unspecified reset mechanism of the conductor connection terminal 1.

Generally, the proposed actuating principle can be extended to any number of displacement stages with further interacting actuation contours and effective contours.

As an alternative to the actuating pushers shown in the examples, an actuator 6 with a different direction of displacement is conceivable, e.g., a swiveling actuating lever in which the first and second actuation contours lie on a curved track. An actuator 6 that can be shifted translationally by means of a tensile force is also conceivable as an actuating pusher.

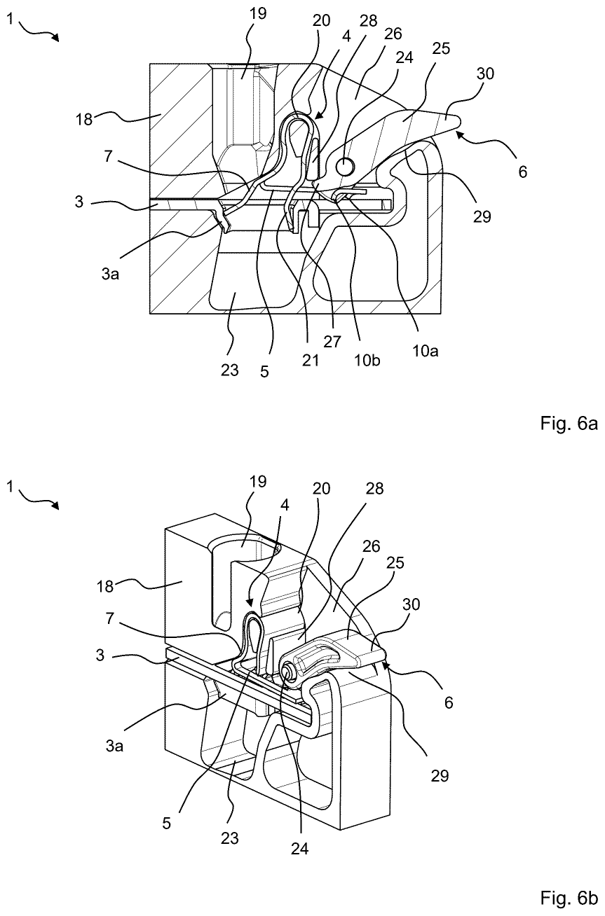

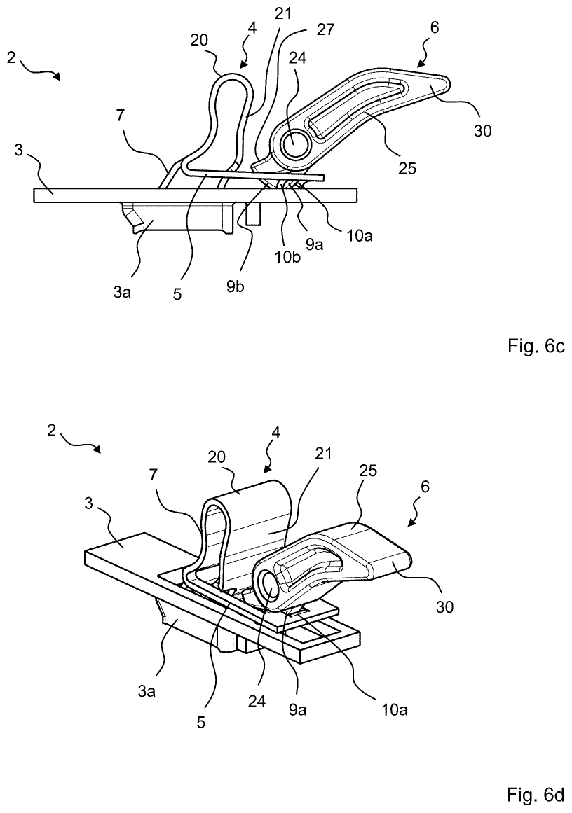

FIG. 6a shows a side-cut view of a second example of a conductor connection terminal 1 with a swiveling actuator 6 in the closed position.

The conductor connection terminal 1 has an insulating material housing 18 with a conductor insertion opening 19. A spring-force clamping connection 2 with a busbar 3 and a clamping spring 4 is installed in the insulating material housing 18. The busbar 3 has a through-hole opening bordered by a pull-through collar 3a, into which the clamping leg 7 and the contact leg 21 of the clamping spring 4 protrude. The conductor insertion opening 19 opens out towards the push-through opening. The insulating material housing 18 has a conductor collection pocket 23 on the side of the busbar 3, which is opposite the conductor insertion opening 19, for the holding an electrical conductor inserted into the conductor insertion opening 19 and through the conductor through-hole opening of the busbar 3.

The structure of the clamping spring 4 is essentially the same as the first example. An actuation section 5 protrudes from the clamping leg 7, which interacts with an actuator 6 (i.e., an actuating lever 25) which is pivoted about a swivel axis 24. The actuator 6 is accommodated in an actuation opening 26 in the insulating material housing 18.

The swivel axis 24 can be formed as shown from a bearing pin of the insulating material housing 18 and a bearing opening in the actuator 6. An inverted variant with a bearing pin on the actuator 6, which is immersed in a bearing opening in the insulating material housing 18, is also possible. It is also conceivable to support a ring-shaped bearing web that is immersed in a corresponding ring-shaped bearing groove. The actuator 6 can also be floating, so that the swivel axis moves during the swivel process.

The actuating lever 25 has an end stop 27, which strikes at a stop contour 28 of the insulating material housing 18. The stop contour 28 is aligned with the end stop 27 and the swivel axis in such a way that the stop contour 28 forms a stop for the actuating lever 25 in the closed clamping position and further swiveling is prevented. The stop contour 28 may be formed in a single piece with the insulating material housing 18 adjacent to the contact leg 21.

FIG. 6b shows a perspective view of the conductor connection terminal 1 from FIG. 6a.

It can be seen that the actuating lever 25 rests on an end wall 29 limiting the actuation opening 26 and that an actuation end 30 of the actuating lever 25 protrudes from the contour outline of the insulating material housing 18. The end stop 27 is located on the end of the actuating lever 25, which is diametrically opposed to the actuation end 30.

FIG. 6c shows a side view of a spring-force clamping connection 2 with a swiveling actuator 6 of the conductor connection terminal 1 from FIGS. 6a and 6b.

It can be seen that the actuating lever 25 has a first actuation contour 9a, which interacts with the first actuation contour 10 a, which protrudes from the actuation section 5. The first actuation contour 9a is immersed in an opening of the actuation section 5, which is bounded on the front side by the first effective contour 10a, which is formed as a material flap. The actuating lever 25 also has a second actuation contour 9b offset from the first actuation contour 9a, which interacts with the second effective contour 10b of the actuation section 5.

The end stop 27 is designed as the front platform of a narrower end section of the actuating lever 25 protruding from the swivel bearing 24. The first and second effective contours 10a, 10b are also formed on this narrower end section.

FIG. 6d shows a perspective view of the spring-force clamping connection 2 with a swiveling actuator 6 from FIG. 6c.

It can be seen that the narrower end section with the first actuation contour 9a is immersed in the opening of the actuation section 5 next to the first effective section 10a.

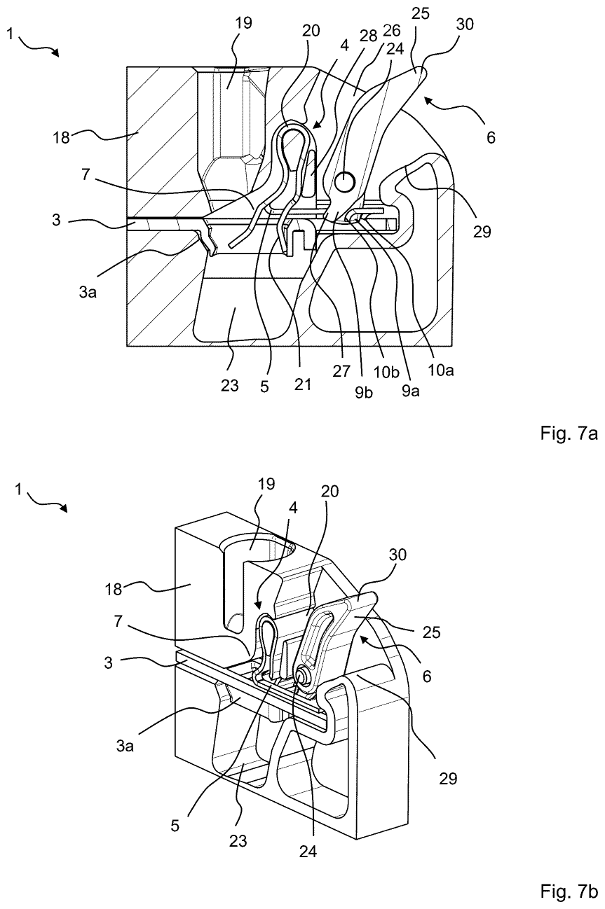

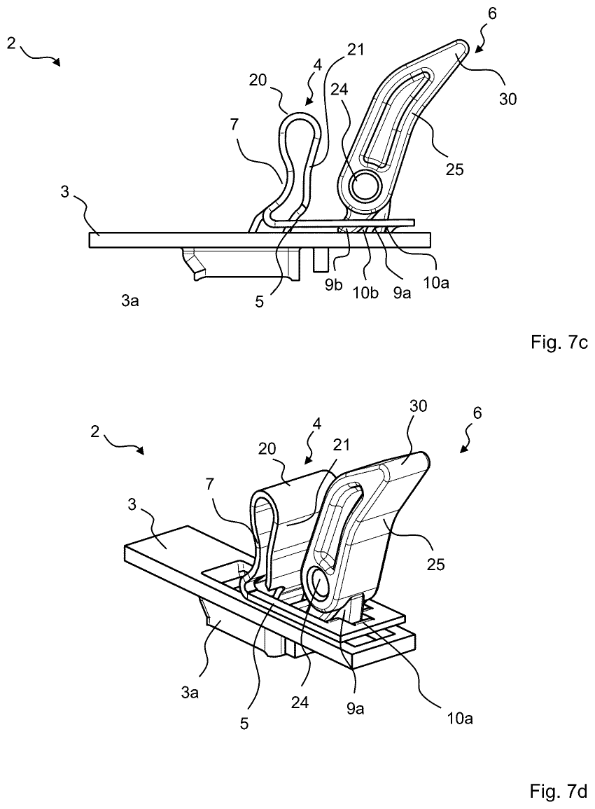

FIG. 7a shows a side-sectional view of the second example of the conductor connection terminal 1 with a swiveling actuator 6 in a partially open position.

It becomes clear that after a partial swiveling of the actuating lever 25, the second actuation contour 9b engages with the second effective contour 10b at the actuation section 5.

FIG. 7b shows a perspective view of the conductor connection terminal 1 from FIG. 7a in the partially open position. The actuating lever 25 is swiveled upwards and can also be swiveled clockwise and counterclockwise in both directions.

FIG. 7c shows a side view of the spring-force clamping connection 2 and FIG. 7d shows a perspective view of the spring-force clamping connection 2 with a swiveling actuator 6 of the conductor connection terminal 1 from FIGS. 7a and 7b in the partially open position. Both the first actuation contour 9a and the second actuation contour 9b are adjacent to the first effective contour 10a and the second effective contour 10b, respectively, in order to shift the clamping leg 7 towards the contact leg 21 or the actuating lever 6 with the help of the actuation section 5 by further swiveling in the counterclockwise view about the swivel axis 24.

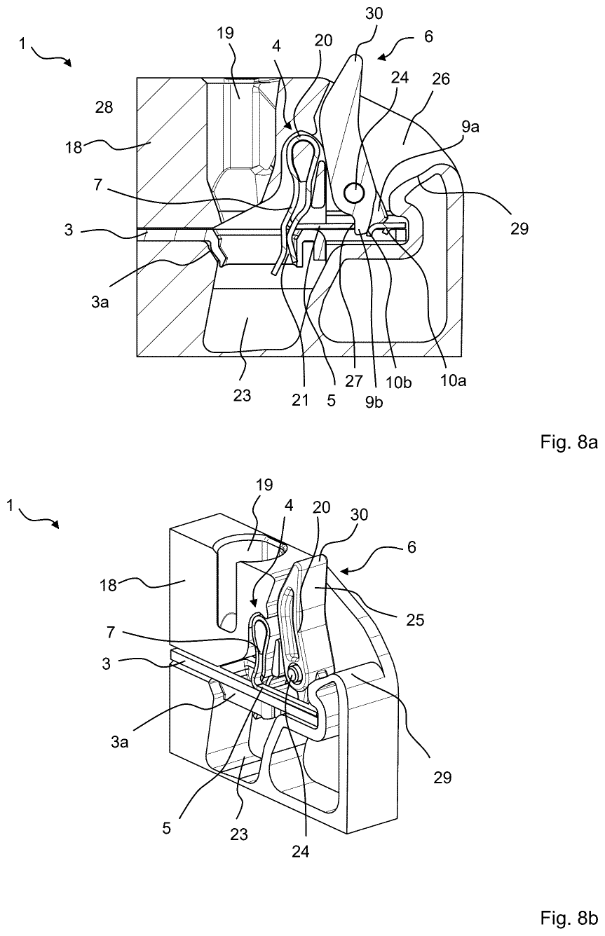

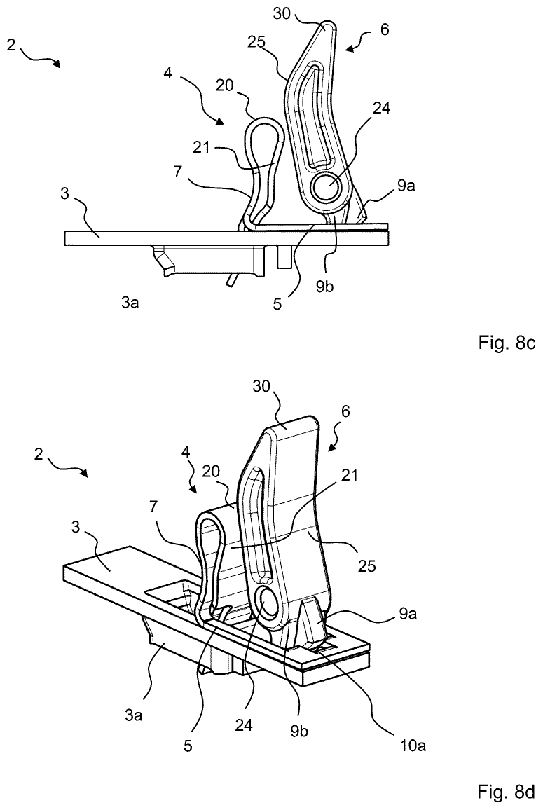

FIG. 8a shows a side-section view and FIG. 8b a perspective view of the second example of the conductor connection terminal 1 with a swiveling actuator 6 in the open position.

The first actuation contour 9a has largely swiveled out of the opening in the actuation section 5 and is no longer engaged with the first effective contour 10a. The second actuation contour 9b, on the other hand, rests on the second effective contour 10b, so that the actuation section 5 together with the clamping leg 7 connected to it is displaced to such an extent that the clamping leg 7 rests against the contact leg 21 and the clamping point formed between the busbar 3 and the clamping edge at the free end of the clamping leg 7 is open for the clamping of an electrical conductor.

FIG. 8c shows a side view and FIG. 8d shows a perspective view of the spring-force clamping connection 2 with a swiveling actuator 6 of the conductor connection terminal 1 from FIGS. 8a and 8b in the open position.

The two offset first and second actuation sections 9a, 9b are recognizable on the narrower end section of the actuating lever 25 adjacent to the swivel bearing 24. The first actuation contour 9a is narrower than the second actuation contour 9b. In addition, the first actuation contour 9a is arranged behind the second actuation contour 9b when viewed in the direction of the contact leg 21 toward the swivel bearing 24. The first and second actuation contours 9a, 9b merge into each other in one step.

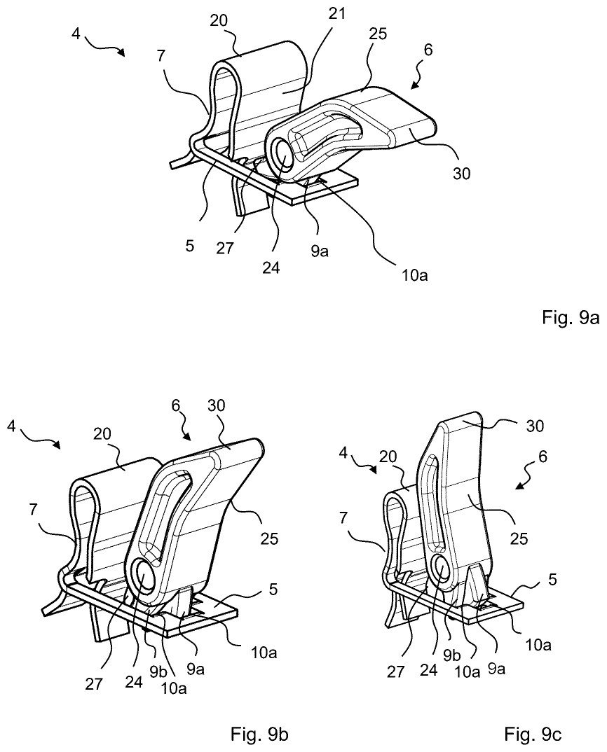

FIG. 9a shows a perspective view of the spring-force clamping connection 2 with a swiveling actuator 6 in the closed position without busbar 3.

It can be seen that the actuating lever 25 has a narrow end section with an end stop 27 connected to the swivel bearing 24. In the closed position, the end stop 27 is positioned adjacent to the contact leg 21 and has a stop plane. A perpendicular standing on the stop plane roughly cuts the spring arch 20.

It also becomes clear that the first effective contour 10a in the actuation section 5 is formed at a narrow bay at the end of an opening in the actuation section 5. The first actuation contour 9a, which is designed as a correspondingly narrow web-like projection, protrudes into this bay and comes into contact with the first effective contour 10a, which is formed there on the end wall.

At the transition of the wider opening into the narrower bay, the end walls there form the second effective contour 10b. The wider section of the actuating lever 25 adjoining the narrow web-like projection with the first actuation contour 9a with a step has the second actuation contour 9b. This second actuation contour 9b is offset in the direction of the first actuation contour 10a to the contact leg 21 toward the first actuation contour 9a. The first and second actuation contours 9a, 9b are arranged one after the other on a circular path around the swivel axis 24 as the center of the circle, which intersects the first and second effective contours 10a, 10b, so that they come into contact with the respective first or second effective contour 10a, 10b one after the other at a different swivel angle during a swivel movement.

FIG. 9b shows a perspective view of the spring-force clamping connection 2 with a swiveling actuator 6 in the partially open position.

It becomes clear that the first actuation contour 9a interacts with the first effective contour 10a in order to displace the actuation section 5 by applying force to the first effective contour 10a. The second actuation contour 9b does not yet interact with the second effective contour 10b.

FIG. 9c shows a perspective view of the spring-force clamping connection 2 with a swiveling actuator 6 in the open position.

The first actuation contour 9a is largely swiveled out of the bay with the first effective contour 10a and no longer exerts any significant force on the first effective contour 10a. Now the second actuation contour 9b comes into contact with the second effective contour 10b in order to displace the actuation section 5 by applying force to the second effective contour 10b.

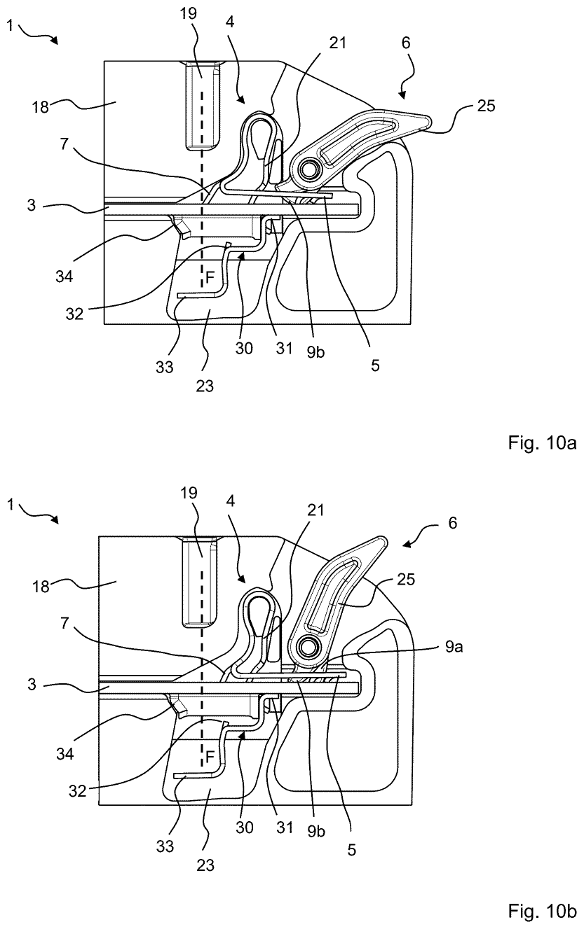

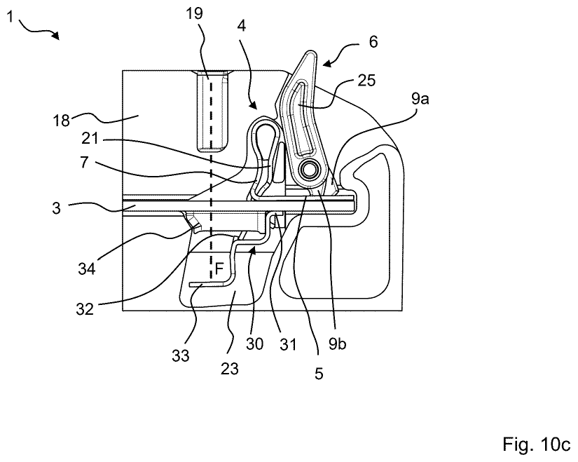

FIG. 10a shows a side view of the second example of the conductor connection terminal 1 with a swiveling actuator 6 in the closed position and with a hold-open release element 30.

The design of the spring-force clamping connection 2 and the actuator 6 is comparable to the design described above. Now an additional hold-open release element 30 is provided.

FIG. 10b shows a side view of the conductor connection terminal 1 from FIG. 10a with a swiveling actuator 6 in the partially open position and with a hold-open release element 30. The hold-open release element 30 is fixed with a fastening section 31 on the busbar 3 or optionally on the insulating material housing 18. After a bend, it extends into the conductor collection pocket 23 and has a detent contour 32 in the form of a detent tab protruding toward the busbar 3. This can be exposed in a bend from the sheet metal material of the hold-open release element 30. The hold-open release element 30 ends with a release section 33, which is transversely aligned with the conductor insertion opening 19 (i.e., the conductor insertion channel). This means that an electrical conductor inserted into the conductor insertion opening 19 hits the release section 33 in order to move it together with the detent contour 32 connected to it.

FIG. 10c shows a side view of the conductor connection terminal 1 from FIG. 10a with a swiveling actuator 6 and clamping leg 7 locked in the open position on the detent contour 32 of the hold-open release element 30. For this purpose, the clamping leg 7 is shifted toward the contact leg 21 by swiveling the actuating lever 25 and applying force to the actuation section 5 until the free end of the clamping leg 7 reaches behind the detent contour 32. The detent contour 32 thus forms a stop for the clamping leg 7, which presses against the detent contour 32 due to the spring force of the clamping spring 4 and engages there.

An electrical conductor can now be inserted into the conductor insertion opening 19 and guided past the clamping point that has been held open. It hits the release section 33 and exerts a release force in the direction of the conductor insertion, which displaces the spring-elastic hold-open release element 30 together with the detent contour 32 and unlocks the clamping leg 7. The clamping leg 7 can then move freely to the clamping section 34 on the busbar 3 by the spring force of the clamping spring 4 and clamp the electrical conductor between the clamping edge at the free end of the clamping leg 7 and the clamping section 34.

Such a hold-open release element 30 can also be used in the conductor connection terminal 1 of the first example with the actuating pusher or other actuators.

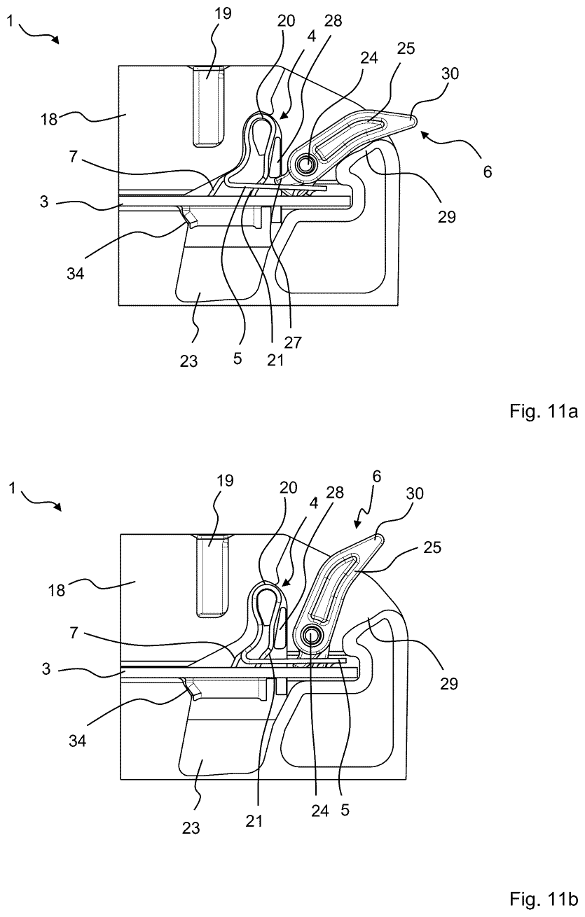

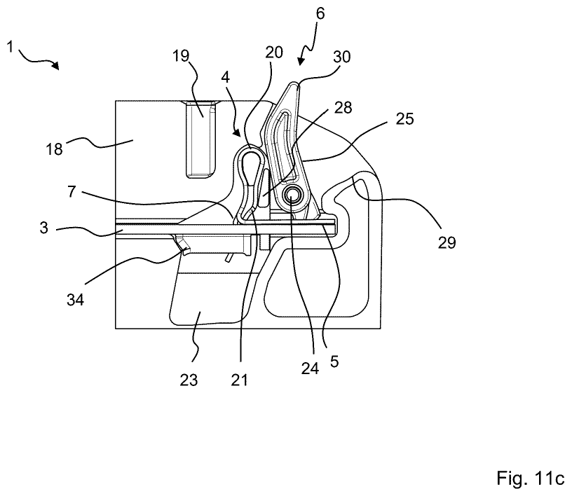

FIG. 11a shows a side view of the conductor connection terminal 1 from FIG. 6a with the swiveling actuator 6 in the closed position. The insulating material housing 18 can be opened at the side to insert the spring-force clamping connection 2 with the busbar 3, the clamping spring 4 and the actuating lever 25 into the insulating material housing 18.

FIG. 11b shows a side view of the conductor connection terminal 1 from FIG. 7a with the swiveling actuator 6 in the partially open position.

FIG. 11c shows a side view of the conductor connection terminal 1 from FIG. 8a with a swiveling actuator in the open position.

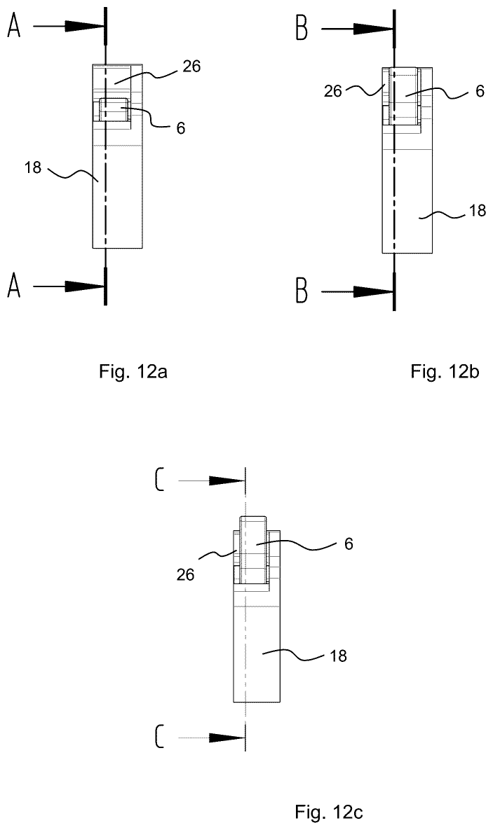

FIG. 12a shows a front view of the conductor connection terminal 1 with the section line A-A of the section view from FIG. 6a with the swiveling actuator 6 in the closed position.

FIG. 12b shows a front view of the conductor connection terminal 1 with the section line B-B of the section view from FIG. 7a with the swiveling actuator 6 in the partially open position.

FIG. 12c shows a front view of the conductor connection terminal 1 with the section line C-C of the section view from FIG. 8a with the swiveling actuator 6 in the open position.

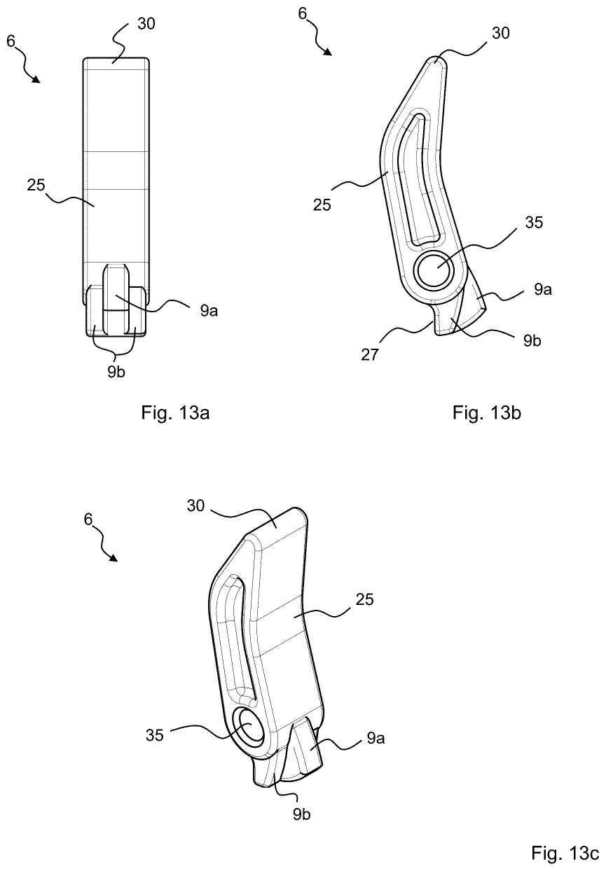

FIG. 13a shows a front view of the actuating lever 25 for the second example of the conductor connection terminal 1. It can be seen that at the end of the actuating lever 25, opposite to the actuation end 30, a protruding central web is used to form the first actuation contour 9a. The web merges into a widened section. In this transition, a step is formed on both sides next to the web, which forms the second actuation contour 9b.

FIG. 13b shows a side view of the actuating lever 25 from FIG. 13a. It becomes clear that there is a bearing opening 35 for the swivel bearing 24. The bearing opening is connected to the web with the first actuation contour 9a and the wider section with the second actuation contour 9b offset from the first actuation contour.

FIG. 13c shows a perspective view of the actuating lever 25 from FIGS. 13a and 13b. It becomes clear that the first and second actuation contours 9a, 9b are arranged radially from the bearing opening 35 and are each offset from each other. The first actuation contour 9a is present on a triangular web, wherein the front side facing away from the actuation end 30 may be curved.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
a spring-force clamping connection, which has a busbar and a clamping spring for connecting an electrical conductor to the busbar via the clamping spring, an actuation section of the clamping spring having a first effective contour (10a) and a second effective contour; and
an actuator acting on an actuation section of the clamping spring for displacing a clamping leg of the clamping spring from a clamping position to an open position, the actuator having a first pusher section with a first actuation contour and a second pusher section with a second actuation contour, the actuator being configured to:
displace the clamping leg of the clamping spring by a first displacement distance through interaction of the first actuation contour with the first effective contour when the actuator is displaced by a first actuation distance, and
displace the clamping leg of the clamping spring by a second displacement distance through interaction of the second actuation contour with the second effective contour when the actuator is displaced by a second actuation distance.

2. The conductor connection terminal according to claim 1, wherein the actuation section of the clamping spring is designed as a clamping yoke.

3. The conductor connection terminal according to claim 2, wherein the first and second effective contours of the clamping yoke are formed as guide surfaces protruding from the clamping yoke and spaced from each other.

4. The conductor connection terminal according to claim 2, wherein the clamping yoke has a first engagement area with a first guide contour for the first pusher section of the actuator and a second engagement area with a second guide contour for the second pusher section of the actuator.

5. The conductor connection terminal according to claim 4, wherein the first engagement area has a smaller cross-sectional area than the second engagement area and wherein the first pusher section has a smaller cross-sectional area than the second pusher section.

6. The conductor connection terminal according to claim 1, wherein the first actuation contour and/or the second actuation contour of the actuator is designed as a ramp surface.

7. The conductor connection terminal according to claim 6, wherein the first actuation contour and the second actuation contour point in a same direction.

8. The conductor connection terminal according to claim 6, wherein the respective angle of inclination of the first and second actuation contours designed as ramp surfaces are different from each other in relation to a longitudinal axis of the actuator.

9. The conductor connection terminal according to claim 1, wherein the first actuation contour forms an end face of the actuator.

10. The conductor connection terminal according to claim 1, wherein the second actuation contour is offset in steps to the first actuation contour.

11. The conductor connection terminal according to claim 1, wherein the actuator has two second actuation contours offset in steps to the first actuation contour on opposite sides of the first actuation contour.

12. The conductor connection terminal according to claim 1, wherein the busbar and/or the clamping spring has a guide section on which the actuator is adapted to slide off during its displacement.

13. The conductor connection terminal according to claim 1, wherein the spring-force clamping connection has a reset mechanism which is set up for the automatic displacement of the clamping leg from the open position to the clamping position when a conductor is inserted into the conductor connection terminal.

14. The conductor connection terminal according to claim 1, wherein the actuator is a translationally displaceable actuating pusher.

15. The conductor connection terminal according to claim 14, wherein the first pusher section is offset from the second pusher section in a direction of the translational displacement of the actuating pusher.

16. The conductor connection terminal according to claim 1, wherein the actuator is a swiveling actuating lever.

17. The conductor connection terminal according to claim 16, wherein the first pusher section is offset from the second pusher section in their direction of movement described on a respective curved track when the actuating lever is swiveled.
